(19) United States
(12) Patent Application Publication
(10) Pub. No.: US 2009/0006506 A1
(43) Pub. Date: Jan. 1, 2009

(54) METHOD AND SYSTEM FOR GARBAGE COLLECTION OF NATIVE RESOURCES

(75) Inventor: CRISTIANO DiFlora, Lempaala (FI)

Correspondence Address: BANNER & WITCOFF, LTD., 1100 13th STREET, N.W., SUITE 1200, WASHINGTON, DC, 20005-4051, US

(73) Assignee: NOKIA CORPORTION, Espoo (FI)

(21) Appl. No.: 11/769,867

(22) Filed: Jun. 28, 2007

(51) Int. Cl. G06F 12/08; G06F 17/30

(52) U.S. Cl. 707/206; 707/E17.002

(57) ABSTRACT

A system and method for enabling automatic and fast garbage collection of native resources. Native code of mixed-language components is directed to perform dynamic allocation of native entities (such as objects, structures, etc.) through a Native Entity Factory (NEF) component instead of using low-level native language operators. Using the NEF component enables tracing dynamic native entity allocations, and driving a virtual machine garbage collector component based on native-heap activity.

### FIELD OF THE INVENTION

This invention relates generally to memory management, and more particularly to mixed-code components running on platforms with garbage collectors.

### BACKGROUND OF THE INVENTION

Languages such as Java, C# and Lisp, are based on dynamic resource management utilizing a garbage collection system. Garbage collection (GC) takes care of freeing dynamically allocated memory that is no longer referenced. Because the objects in the Java heap are garbage collected, Java programmers don't have to explicitly free allocated memory. Garbage collection has also been implemented in other languages, such as C and C++.

Garbage collection is implemented as a part of a managed runtime platform, such as the Java virtual machine (JVM). Restricted embedded devices, such as mobile terminals, need to have an optimized runtime platform, especially in terms of their memory footprint. This means that a simple garbage collection utility is usually implemented in a mobile terminal JVM.

Java classes include features to assist with garbage collection. The java.lang.object class has a protected method called “finalize”. This finalize method can be invoked to perform cleanup for objects of defined classes. JVM implementations guarantee that any finalizer methods will be called for objects of the defined class before the object is reclaimed by garbage collection. A mixed-language class (i.e., a class having one or more methods implemented in a different programming language than Java) can override this finalize method to dispose of system resources or to perform cleanup before an object of that class is reclaimed by garbage collection. An object that has a finalizer will not be garbage collected until its finalizer is run, however JVM implementations provide no guarantee when a finalizer will be run or that it will be run at all.

Using finalizers for disposing of native resources associated to a mixed-language Java component is a challenging task. Mixed-language objects that are pending for finalization will retain memory and other resources allocated in Java and in native contexts, even though the objects are no longer referenced by the application, which can lead to problems including memory leaks. Memory leaks typically occur when an application fail to release memory no longer used by that application, and over time the available memory shrinks and causes system degradation or instability.

Applications should release native resources as soon as possible, but Java finalizers do not guarantee timely de-allocation of native resources since they are run only when the garbage-collection mechanism is run, which can result in a very long delay until the release of the native resources. This can occur in a situation where a large Java heap, with plenty of free space left on the Java heap, but intensive dynamic allocation is performed on the native heap, in that a finalizer may never be invoked to free up objects on the native heap, even though there may be unreferenced objects.

Therefore, there is a need in the art for a system and method for enabling fast and automatic garbage-collection of native objects and variables instantiated by a mixed-language component running on a virtual machine.

### SUMMARY OF THE INVENTION

The present invention includes an embodiment that enables automatic and fast garbage collection of native resources. Native code of mixed-language components is directed to perform dynamic allocation of native entities (objects, structures, primitive variables) through a Native Entity Factory (NEF) component, rather than using low-level native language operators (e.g. new( ) operator for C/C++ runtimes). Using the NEF component enables tracing dynamic native entity allocations, and driving a virtual machine garbage collector component based on native-heap activity.

As a result, managed code does not need to call a destructor explicitly. In addition, finalization of unreferenced mixed-language components is executed based on native-heap status rather than on Java-heap status by means of a two-state approach that allows reducing the runtime scanning overhead associated to high-performance object garbage collection.

An embodiment of the present invention includes a method comprising receiving a request to create an object in a native heap, the object associated with a managed component; creating the object in the native heap; and maintaining an identifier for the object along with a priority indication. Then based on the priority indication, the embodiment includes determining whether to scan the managed component for an indication that the managed component may be garbage collected. The step of determining to scan the managed component may include periodically scanning the managed component, and/or indicating to a garbage collector to periodically scan managed components. It may also include indicating to the garbage collector to stop periodically scanning managed components.

The embodiment may determine whether to stop scanning managed components, either after a garbage collection, or at some other time.

The priority indication may indicate a priority for disposing of the object when it is no longer needed. This priority indication may be provided with the request to create the object. The determination whether to scan the managed component may also be based on a size of the object.

The embodiment may include a feature wherein the managed component is managed by a virtual machine, such as a Java Virtual Machine (JVM). Typically, when the managed component is garbage collected, the object in the native heap is disposed of, such as by a finalizer.

Another embodiment of the present invention includes an apparatus with a native entity factory component that receives a request to create an object in a native heap, the object associated with a managed component. The native entity factory component creates the object in the native heap, and also supplies an identifier for the object along with a priority indication to a native heap collector component. The native heap collector component determines, based on the priority indication, whether to indicate to a garbage collector to scan the managed component for an indication that the managed component may be garbage collected.

Another embodiment of the present invention includes a machine-readable medium having machine-executable instructions for instructing a processor to perform steps including receiving a request to create an object in a native heap in a memory, the object associated with a managed component; creating the object in the native heap; and maintaining an identifier for the object along with a priority indication. Then, based on the priority indication, the processor performs a step of determining whether to scan the managed component for an indication that the managed component may be garbage collected.

Still another embodiment includes a mobile device with a processing component and a memory component, coupled to the processing component. The memory component includes instructions, that when provided to the processing component, cause the processing component to perform steps including providing a virtual machine, for creating and managing managed components, the virtual machine including a garbage collector. Further steps include receiving a request to create an object in a native heap separate from the virtual machine, the object associated with a managed component in the virtual machine; creating the object in the native heap; and maintaining an identifier for the object along with a priority indication. Then, based on the priority indication, the steps include determining whether to instruct the garbage collector to periodically scan the managed component for an indication that the managed component may be garbage collected; and upon garbage collecting the managed component, determining whether to indicate to the garbage collector to stop periodically scanning managed components.

An advantage of this embodiment is that managed code does not need to call a destructor explicitly. As another advantage, finalization of unreferenced mixed-language components is executed based on the native heap status, rather than on the Java heap status. Yet another advantage is that a two state approach may reduce the runtime scanning overhead associated with high-performance object garbage collection.

### BRIEF DESCRIPTION OF THE DRAWINGS

FIG. 1 is a block diagram showing an embodiment of the present invention;

FIG. 2 is a flowchart of a method according to one embodiment;

FIG. 3 is a block diagram showing another embodiment of the present invention; and

FIG. 4 is an apparatus for running an embodiment of the present invention.

### DETAILED DESCRIPTION OF THE INVENTION

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

An embodiment of the present invention relates generally to native resources created and used from Java classes. More particularly, aspects of this embodiment relate to apparatuses and methods for easing and speeding disposal of the so-called mixed language (a.k.a. mixed-mode code) Java classes, i.e., classes having one or more methods implemented in a different programming language than Java. However, the concepts are quite general, and they can be easily applied to different virtual-machines and managed runtime environments.

In order to assist with automatic and fast garbage-collection of native resources, an embodiment of the present invention allows native code of mixed-language components to perform dynamic allocation of native entities (objects, structures, primitive variables, etc.) through a Native Entity Factory (NEF) component, instead of using low-level native language operators (e.g. the new( ) operator for C/C++ runtimes).

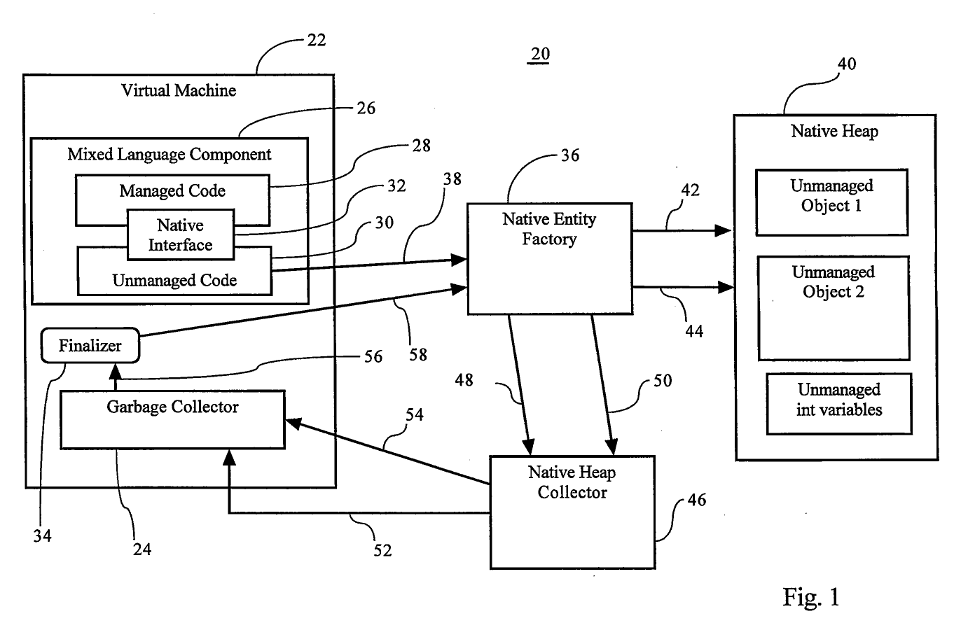

A system 20 in accordance with one embodiment is illustrated in FIG. 1. A virtual machine (VM) environment 22 is provided on some platform. The VM 22 includes a mechanism for embedding native code (such as unmanaged code 30) into managed components, and a garbage collector 24 to perform memory management, at least for the managed code 32 and its related heap (not shown). The VM 22 also includes an ability to define finalizer methods 34 for such managed components.

A mixed language component 26 is shown running on the VM platform 22. This mixed language component 26 includes managed code 28, which for a Java VM would be Java classes and code. The mixed language component 26 includes some unmanaged code 30, which typically would be code or methods implemented in a programming language other than the managed code 28. Such mixed language component 26 may include a native interface component 32 or other interface features to allow the managed code 28 to work with the unmanaged code 30.

The managed code 28 in the mixed language component 26 allocates objects in the standard way on the VM platform 22, which for a Java platform means using a new( ) method or other allocation method. The unmanaged code 30 however, allocates objects by a call to an NEF component 36, such as a “create new entity” call as shown by arrow 38.

This NEF component 36 enables tracing dynamic native entity allocations and driving a VM garbage-collector component 24 based on native heap activity. The NEF component 36 keeps track of some or all native memory allocations and de-allocations performed by mixed-language components, such as mixed language component 26.

The NEF component 36 may send requests to allocate new objects in the native heap 40, as shown by arrow 42. The NEF component 36 may also send requests to dispose of memory for objects in the native heap 40, as shown by arrow 44. The NEF component 36 may also inform a Native Heap Collector (NHC) 46 about what entities are allocated or disposed of at run-time by the mixed language component 26, as shown by arrow 48. Such information supplied to the NHC 46 by the NEF 36 may include an identifier for the allocated entity, its size, and a priority, as will be discussed below. The NHC 46 helps handle garbage collection issues. Based on native resource allocation/disposal history, the NHC 46 may determine whether unused native resources need to be garbage collected or not. In one embodiment, the NHC 46 may instruct the VM garbage collector 24 to work in different states or modes. These modes are referred to as Normal Collection (NC) 52, and Fast Native Collection (FNC) 54. The normal mode for the garbage collector 24 is Normal Collection 52. These modes will be described in more detail below.

The garbage collector 24 may utilize finalizers 34 during collection. Depending on the implementation, a finalizer for a native resource may send a request 58 to the NEF component 36 to dispose of such native resources. The NEF component 36 may dispose of such native resources, and may also inform the NHC 46, as shown by arrow 50. Typically the NEF component 36 may supply the identifier of the reclaimed entity to the NHC 46.

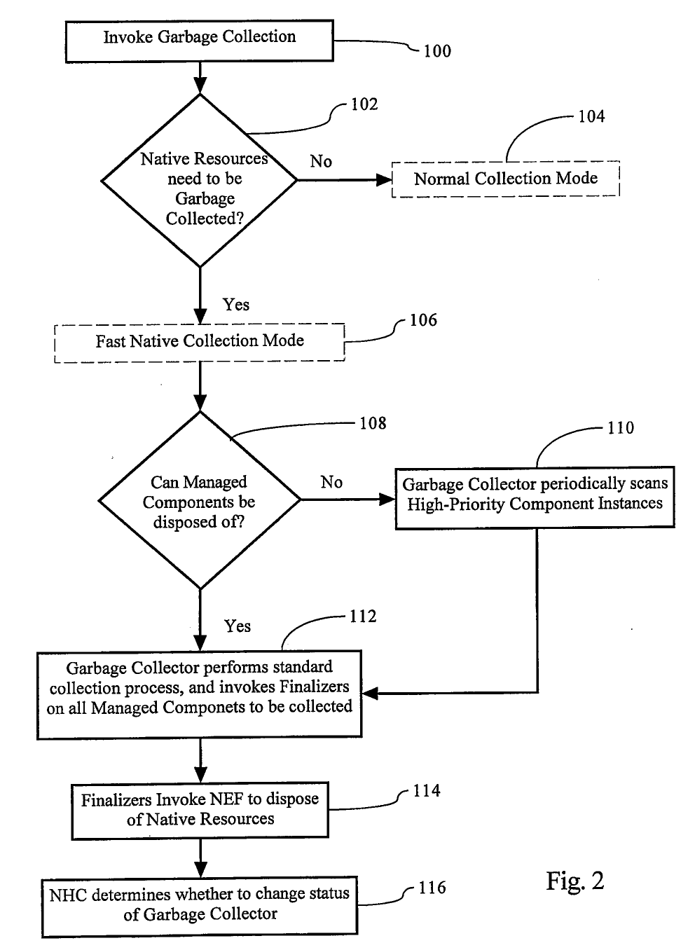

FIG. 2 illustrates steps performed by an embodiment of the present invention. For this embodiment, each native class or data type is assigned a collection priority attribute, which represents how critical is timely garbage collection for a given instance of that class or data type when not needed anymore. High priority means that it is important to dispose of this resource quickly. For example, if an instance consumes a large amount of native heap space, it would be desirable to free up this space quickly to allow other instantiated objects to use the memory.

When a garbage collection is invoked, step 100 FIG. 2, the NHC component determines if garbage collection of native-resources could be required, step 102. If not, then normal collection mode is maintained, step 104, and a typical garbage collection is performed.

If the NHC component determines that garbage collection of native resources may be required (as described below), the NHC component may send a Fast Native Collection event to the VM garbage collector, which in turn puts the garbage collector into the FNC state, step 106. When the garbage collector runs with FNC mode enabled, if some managed components can be disposed of (e.g. there are unreferenced components) step 108, the garbage collector then performs standard managed component collection process, step 112 including invoking finalizers on all the managed components to collect, step 114. Such finalizers may explicitly invoke the NEF component in order to dispose of native resources, as described earlier. For this embodiment, each mixed language component should implement a finalize( ) method in such a way that it explicitly disposes of all dynamic native resources allocated by its own mixed-language component. This may help prevent excessive scanning overhead for the VM process, depending on the mode of the VM garbage collector.

Eventually disposable high priority components will be finalized during normal garbage-collection process.

If FNC mode is enabled but no managed-components can be disposed of (e.g. there are no unreferenced components) as determined at step 108, the garbage collector starts periodically scanning high priority managed components in order to identify any disposable time critical components, step 110. Therefore, in this FNC mode, the garbage collector will actively perform periodic scans of managed components instead of waiting until another garbage collection is invoked. In this way, once any high-priority managed components are no longer referenced, they may be garbage collected and their associated non-managed components in the native heap will be disposed of in a timely manner.

Determining the timing of scanning may be based on factors such as the scanning overhead, the need to reclaim components, heap size, etc. Such timing may be dynamically varied as factors change. When one or more disposable time-critical mixed-language components are identified, the garbage collector issues standard managed component collection process and invokes finalizers on all the managed components to collect, step 112.

Upon disposal of native entities, the NHC component decides whether to instruct the garbage collector to change its status from FNC to NC, or to not send any events to the garbage collector in order to let it remain in the FNC status, step 116.

An advantage of this embodiment is that managed code does not need to call a destructor explicitly. As another advantage, finalization of unreferenced mixed-language components is executed based on the native heap status, rather than on the Java heap status. Yet another advantage is that a two state approach may reduce the runtime scanning overhead associated with high-performance object garbage collection. The garbage collector will only perform run-time scanning when there is a need to free up native heap space.

The NEF may be implemented by using standard native language programming. For example, an implementation of the invention for Java mixed-language components including JNI-based C/C++ business logic, may be implemented as a C/C++ class creating a wide range of static methods to create and dispose new native entities instances (e.g. C++ objects, structures, primitive variables) at run-time. The JNI code implementing the C/C++ side of the mixed-language component should invoke the NEF methods instead of using new( ) and delete( ) operators explicitly.

The NHC component may calculate the value of an implementation-specific cost function for HC(ν₁, . . . , ν_{N}) HC represents native resources allocation/disposal history based on a set (ν₁, . . . , ν_{N}) of input parameters. It enables the NHC component to understand whether unused native resources need to be garbage collected or not.

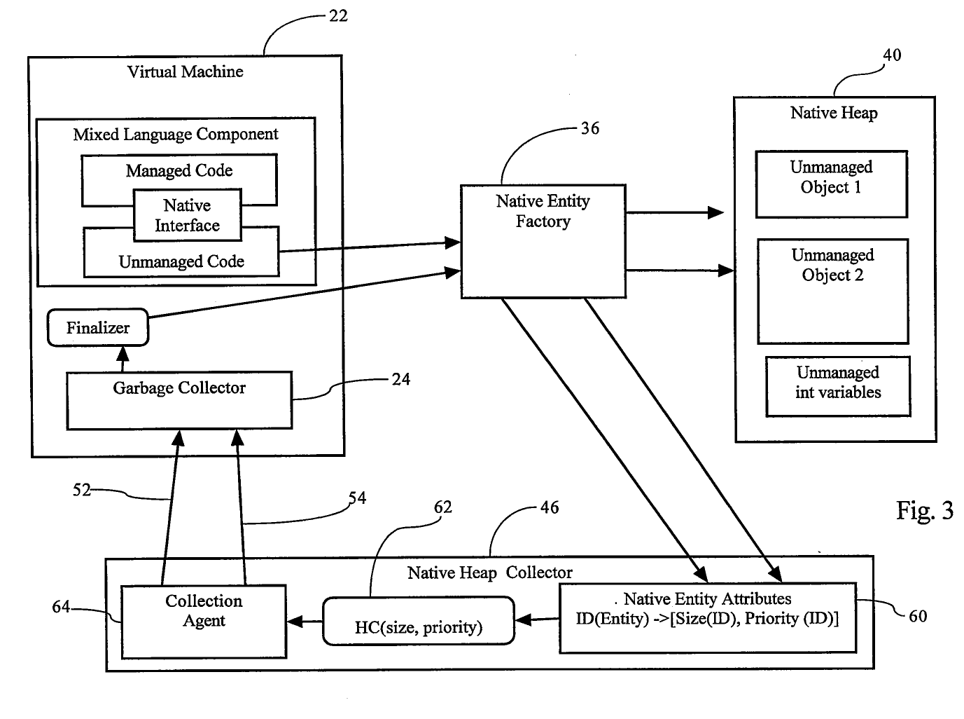

In one embodiment, as illustrated in FIG. 3, the NHC component 46 may rely on a cost function, HC (size, priority) 62 that takes into account both the overall impact of dynamically allocated native entities on the native heap 40 and their collection timing requirements in terms of the collection-priority, as previously described. Other HC functions may also be used. For this embodiment, the NHC component 46 may retrieve a size and priority of each allocated object from an internal Native Entity Attributes table 60, based on the unique identifier of the entity to create or remove. Subsequently, the NHC component may calculate the HC function could as follows:

HCₖ(s_{ID}, p_{ID})=HCₖ₋₁+Δₖ(s_{ID}, p_{ID})

S_{ID} is the size of the object identified by the identifier ID, and P_{ID} is the priority for that object. The increment Δₖ(S_{ID},P_{ID}) can be either positive or negative, and may be calculated as follows:

$$∀ \{ \begin{matrix}{WS}_{FNC} , {WP}_{FNC} > 0 \\ {WS}_{NC} , {WP}_{NC} < 0\end{matrix} ⇒ ( {WS}_{k} , {WP}_{k} ) = \{ \begin{matrix}( {WS}_{FNC} , {WP}_{FNC} ) ⇐ u ( k ) = allocated \\ ( {WS}_{NC} , {WP}_{NC} ) ⇐ u ( k ) = disposed\end{matrix} \\ {Δ}_{k} = {WS}_{k} \cdot {s}_{ID} + {WP}_{k} \cdot {p}_{ID}$$

Generally, when a new entity is allocated or an existing one is disposed of, the current value of HC, i.e., HCₖ, is incremented or decremented accordingly. The actual value of the increment at k^{th} operation (Δₖ) is calculated based on size and priority of the allocated native object. Size and priorities are weighted by using two different factors, namely WSₖ and WPₖ. Each factor can assume one of two predefined values (e.g. WS_{FNC} or WS_{NC} which correspond to the modes as described earlier), used to apply positive or negative increments upon allocation or removal respectively. If the current value of the HC function does not match some reference rules (e.g. is higher than a given threshold), the collection agent component 64 sends an FNC event 54 to the garbage collector 24, which in turn puts the garbage collector 24 into FNC mode.

Upon disposal of native objects, the NHC 46 may calculate the new value of the HC function 62 by using, for example, the first equation listed above, and eventually invokes the collection agent component 64 as follows:

If the current value of the HC function matches again the reference rules (e.g. is lower or equal to a given threshold), the collection agent component 64 sends an NC event 52 to the garbage collector 24 in order to change its mode from FNC to NC.

If the current value of the HC function does not match the reference rules (e.g. is still higher than the given threshold), the collection agent component 64 does not send any events to the garbage collector 24, which will remain in NFC mode.

This embodiment may rely on a static large table of native-entities meta-data to assign each native platform's type (classes, primitive data types, structures, unions) a unique ID. In this way messaging/invocation overhead associated to interaction between the NEF and the NHC components can be reduced.

In order to distinguish and track high-priority mixed-language components from other mixed-language components, an embodiment may provide helper managed classes or interfaces that developers can specialize when implementing their own high-priority components. In this way, the active scanning performed by the managed runtime's garbage collector when running in FNC mode can be faster and effective since the garbage collector could search only for high-priority orphaned objects.

If modifying an existing VM garbage collector is an issue, an embodiment of the invention may be implemented by adding an additional Native Garbage Collector (NGC) component to the virtual machine internals (for example the JVM internals). This NGC component is then in charge of performing active scanning of the High-priority components in order to identify disposable objects and to effectively de-allocate them by invoking finalizers explicitly. It could be in either an active or a sleeping (default) state. For this embodiment, the collection agent component may be modified in such a way that its FNC and NC event are sent to the NGC component, rather than directly to the virtual machine garbage collector. FNC events activate the NGC component, whereas NC events put it in the standby mode.

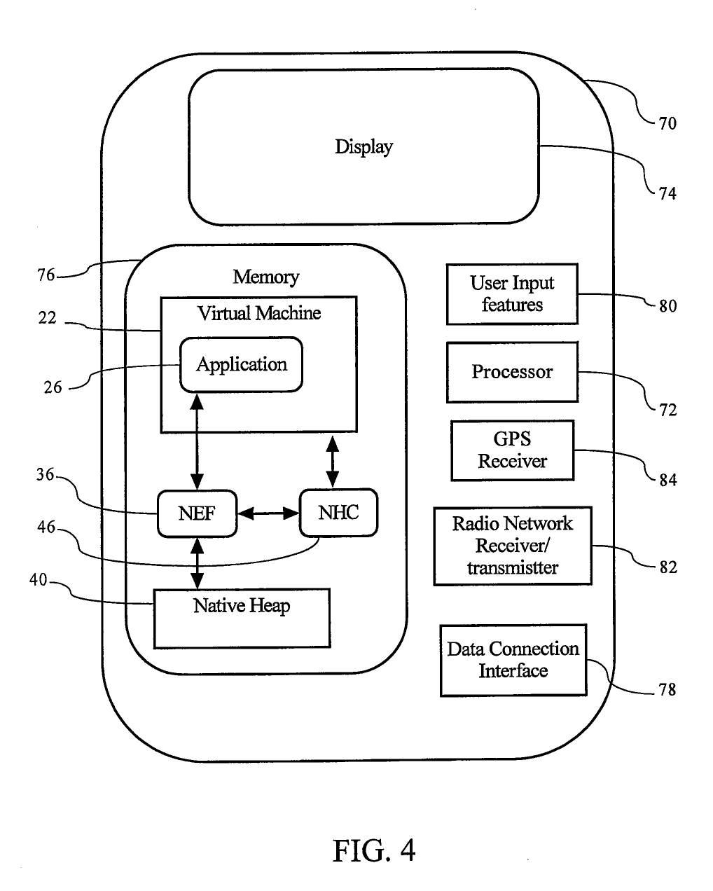

A system for implementing an embodiment of the present invention is shown in FIG. 4 with reference to a mobile device 70. Mobile device 70 may comprise a network-enabled wireless device, such as a digital camera, a cellular phone, a mobile terminal, a data terminal, a pager, a laptop computer or combinations thereof. The mobile device may also comprise a device that is not network-enabled, such as a personal digital assistant (PDA), a wristwatch, a GPS receiver, a portable navigation device, a car navigation device, a portable TV device, a portable video device, a portable audio device, or combinations thereof. Such non network-enabled devices may include RFID tag readers. Further, the mobile device may comprise any combination of network-enabled wireless devices and non network-enabled devices. Although device 70 is shown as a mobile device, it is understood that the invention may be practiced using non-portable or non-movable devices. As a network-enabled device, mobile device 70 may communicate over a radio link to a wireless network (not shown) and through gateways and web servers. Examples of wireless networks include third-generation (3G) cellular data communications networks, Global System for Mobile communications networks (GSM), WLAN networks, or other wireless communication networks. Mobile device 70 may also communicate with a web server one or more ports (not shown) on the mobile device that may allow a wired connection to the Internet, such as universal serial bus (USB) connection, and/or via a short-range wireless connection (not shown), such as a BLUETOOTH™ link or a wireless connection to WLAN access point. Thus, mobile device 70 may be able to communicate with a web server in multiple ways.

As shown in FIG. 4, the mobile device 70 may include a processor 72, a display 74, memory 76, a data connection interface 78, and user input features 80, such as keypads, touch screens etc. It may also include a short-range radio transmitter/receiver 82, a global positioning system (GPS) receiver 84 and possibly other sensors (not shown). The processor 72 is in communication with memory 76 and performs instructions stored therein. The processor 72 is connected to display 74 and generates a display thereon, such as maps other displays. The user input features 80 are also in communication with the processor 72 for providing inputs to the processor. In combination, the user input 80, display 74 and processor 72, in concert with instructions stored in memory 76, generally form a graphical user interface (GUI), which allows a user to interact with the device and modify displays shown on display 74. Data connection interface 78 is connected to processor 72 and enables communication with wireless networks as previously described.

Short-range radio transmitter/receiver 82 is connected to processor 72 and enables communication via short-range radio communications, such as communications via a BLUETOOTH™ link or communications with radio frequency identification (RFID) tags. GPS receiver 84 receives GPS transmissions and communicates with processor 72 to enable the processor to determine current location information for mobile device 70. Mobile device 70 may also take advantage of other positioning mechanisms, such as positioning methods based on communication signals between the mobile device and base stations (e.g., triangulation methods) and proximity based methods (e.g., communication with a BLUETOOTH proximity sensor). Other sensors may be included in mobile device 70, such as accelerometers, cameras, thermometers, microphones, compass, etc. that can provide context information for the mobile device. For instance, accelerometers or a compass within mobile device 70 may provide information in concert with GPS receiver 84 to assist with providing real-time map updates to the user based on user movements along a route. Overall, mobile device 70 is generally a mobile computing device, such as a handheld personal computer, a mobile communication device, and a mobile terminal, that may include a variety of internal components, communication hardware and software, attachments, and the like.

In accordance with instructions in memory 76, the processor performs steps for providing a platform to allow applications to run, such as creating a virtual machine 22. This virtual machine may include one or more garbage collectors (not shown) to do memory management for applications running on the virtual machine 22. When an application 26 runs, it is typically partially or fully loaded into the memory 76. For a mixed language application (or component) 26 in accordance with an illustrative embodiment, an NEF component 36 and NHC component 46 are provided. These components may be part of the virtual machine 22, or separately instantiated as shown. The memory 76 may also include a designated area allocating native objects, referred to as the native heap 40. The NEF component 36 and NHC component 46 interact with the virtual machine 22 and native heap 40 as previously described.

Additionally, the methods and features recited herein may further be implemented through any number of computer readable media that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

I/We claim:

1. A method comprising:
receiving a request to create an object in a native heap, the object associated with a managed component;
creating the object in the native heap;
maintaining an identifier for the object along with a priority indication; and
based on the priority indication, determining whether to scan the managed component for an indication that the managed component may be garbage collected.

2. The method of claim 1 wherein the step of determining to scan the managed component includes periodically scanning the managed component.

3. The method of claim 2 wherein the step of periodically scanning the managed component includes indicating to a garbage collector to periodically scan managed components.

4. The method of claim 3 further including indicating to a garbage collector to stop periodically scanning managed components.

5. The method of claim 3 further including:
after garbage collecting the managed component, determining whether to stop scanning managed components.

6. The method of claim 1 wherein the priority indication indicates a priority for disposing of the object when it is no longer needed.

7. The method of claim 1 wherein the priority indication is provided with the request to create the object.

8. The method of claim 1 wherein when the managed component is garbage collected, the object in the native heap is disposed of.

9. The method of claim 1 wherein determining whether to scan the managed component is also based on a size of the object.

10. The method of claim 1 wherein the managed component is managed by a virtual machine.

11. The method of claim 10 wherein the virtual machine is a Java Virtual Machine (JVM).

12. Apparatus comprising:
a processor;
a memory, coupled to the processor, the memory including instructions, that, when provided to the processor cause the processor to carry out steps of:
receiving a request to create an object in a native heap in the memory, the object associated with a managed component;
creating the object in the native heap;
maintaining an identifier for the object along with a priority indication; and
based on the priority indication, determining whether to scan the managed component for an indication that the managed component may be garbage collected.

13. The apparatus of claim 12 wherein the step of determining to scan the managed component includes periodically scanning the managed component.

14. The apparatus of claim 13 wherein the step of periodically scanning the managed component includes indicating to a garbage collector to periodically scan managed components.

15. The apparatus of claim 14 further including indicating to a garbage collector to stop periodically scanning managed components.

16. The apparatus of claim 14 further including:
after garbage collecting the managed component, determining whether to stop scanning managed components.

17. The apparatus of claim 12 wherein the priority indication indicates a priority for disposing of the object when it is no longer needed.

18. The apparatus of claim 12 wherein the priority indication is provided with the request to create the object.

19. The apparatus of claim 12 wherein when the managed component is garbage collected, the object in the native heap is disposed of.

20. The apparatus of claim 12 wherein determining whether to scan the managed component is also based on a size of the object.

21. The apparatus of claim 12 wherein the managed component is managed by a virtual machine.

22. The apparatus of claim 21 wherein the virtual machine is a Java Virtual Machine (JVM).

23. A machine-readable medium having machine-executable instructions for instructing a processor to perform steps comprising:
receiving a request to create an object in a native heap in a memory, the object associated with a managed component;
creating the object in the native heap;
maintaining an identifier for the object along with a priority indication; and
based on the priority indication, determining whether to scan the managed component for an indication that the managed component may be garbage collected.

24. The machine-readable medium of claim 23 wherein the step of determining to scan the managed component includes periodically scanning the managed component.

25. The machine-readable medium of claim 24 wherein the step of periodically scanning the managed component includes indicating to a garbage collector to periodically scan managed components.

26. The machine-readable medium of claim 25 further including the step of indicating to a garbage collector to stop periodically scanning managed components.

27. A mobile device comprising:
a processing component;
a memory component, coupled to the processing component;
wherein the memory component includes instructions, that when provided to the processing component, cause the processing component to perform the steps of:
providing a virtual machine, for creating and managing managed components, the virtual machine including a garbage collector;
receiving a request to create an object in a native heap separate from the virtual machine, the object associated with a managed component in the virtual machine;
creating the object in the native heap;
maintaining an identifier for the object along with a priority indication;
based on the priority indication, determining whether to instruct the garbage collector to periodically scan the managed component for an indication that the managed component may be garbage collected; and
upon garbage collecting the managed component, determining whether to indicate to the garbage collector to stop periodically scanning managed components.
